(19) United States
(12) Patent Application Publication
(10) Pub. No.: US 2012/0127821 A1
(43) Pub. Date: May 24, 2012

(54) Method For Mixing Liquid Samples In A Container Using A Lemniscate Stirring Pattern

(75) Inventors: William David Dunfee, Newark, DE (US); Richard Renrong Zhang, Hockessin, DE (US); Richard Henry Carter, Merion Station, PA (US); Media Marie Lloyd, Elkton, MD (US)

(73) Assignee: SIEMENS HEALTHCARE DIAGNOSTICS INC., Deerfield, IL (US)

(21) Appl. No.: 13/388,159

(22) PCT Filed: Jul. 20, 2010
(86) PCT No.: PCT/US2010/042600

§ 371 Date: Jan. 31, 2012

Related U.S. Application Data
(60) Provisional application No. 61/230,431, filed on Jul. 31, 2009.

(51) Int. Cl. B01F 13/08

(52) U.S. Cl. 366/142

(57) ABSTRACT

A method for rapidly and uniformly mixing solutions within a biochemical analyzer by rapidly and repeatedly moving a sampling probe in generally lemniscate shaped pattern within the solution is provided.

### FIELD OF THE INVENTION

The present invention relates to a method and apparatus for uniformly mixing liquid samples, reagents, or other solutions in a container. In particular, the present invention provides an improved method for rapidly and uniformly mixing a liquid solution by repeatedly moving a sampling probe needle in a two-dimensional lemniscate-like pattern within the solution.

### BACKGROUND OF THE INVENTION

Various types of analytical tests related to patient diagnosis and therapy can be performed by analysis of a liquid sample taken from a patient's infections, bodily fluids, or abscesses. These assays are typically conducted with automated clinical analyzers onto which tubes or vials containing patient samples have been loaded. The analyzer extracts liquid sample from the vial and combines the sample with various reagents in special reaction cuvettes or tubes. Usually the sample-reagent solution is incubated or otherwise processed before being analyzed. Analytical measurements are often performed using a beam of interrogating radiation interacting with the sample-reagent combination, for example, turbidimetric, fluorometric, absorption readings, or the like. The measurements allow determination of end-point or rate values from which an amount of analyte related to the health of the patient may be determined using well-known calibration techniques.

Clinical analyzers employ many different processes to identify analytes and, throughout these processes, patient liquid samples and samples in combination with various other liquids (such as reagents, diluents, or re-hydrated compositions) are frequently required to be mixed to a high degree of uniformity. Due to increasing pressures on clinical laboratories to increase analytical sensitivity, there continues to be a need for improvements in the overall processing efficiency of clinical analyzers. In particular, sample analysis continuously needs to be more effective in terms of increasing assay throughput. There remains a need for sample-reagent mixers that mix a liquid solution to a high degree of uniformity at very high speed without unduly increasing analyzer cost or requiring a disproportional amount of space.

Various methods have historically been implemented to provide a uniform sample solution mixture including agitation, mixing, ball milling, etc. One popular approach involves using a pipette to alternately aspirate and release a portion of liquid solution within a liquid container. Magnetic mixing, in which a vortex mixing action is introduced into a solution of liquid sample and liquid or non-dissolving reagents has also been particularly useful in clinical and laboratory devices. Such mixing is disclosed in U.S. Pat. No. 6,382,827, wherein a liquid solution in a liquid container is mixed by causing a freely disposed, spherical mixing member to rapidly oscillate within the solution in a generally circular pattern within the container. The spherical mixing member is caused to rapidly move within the solution by revolving a magnetic field at high speed in a generally circular pattern in proximity to the liquid container. Magnetic forces acting upon the magnetic mixing member cause it to generate a mixing motion within the liquid solution.

Ultrasonic mixing techniques such as that described in U.S. Pat. No. 4,720,374 employ ultrasonic energy applied from the exterior of the package and coupled into a reaction compartment so that a solid tablet of material within the compartment is dissolved or so that liquids contained therein are uniformly mixed. The container may include an array of sonication-improving projections mounted therein and spaced from each other to provide recirculating channels that communicate with both the tablet-receiving recess and the remainder of the volume of the container such that, in use, the projections act to confine a tableted material within a relatively high ultrasonic energy zone and simultaneously permit a flow of hydrating liquid from the high energy zone through the channels thereby to rapidly effect the dissolution of the tableted material.

U.S. Pat. No. 6,382,827 discloses a method for mixing a liquid solution contained in a liquid container by causing a freely disposed, spherical mixing member to rapidly oscillate within the solution in a generally circular pattern within the container. The spherical mixing member is caused to rapidly move within the solution by revolving a magnetic field at high speed in a generally circular pattern in proximity to the liquid container. Magnetic forces acting upon the magnetic mixing member cause it to generate a mixing motion within the liquid solution.

U.S. Pat. No. 5,824,276 discloses a method for cleaning contact lenses by applying a solution flow in an oscillatory fashion such that the lens moves up and down within a container but does not contact the container for an extended time period. The method includes suspending the article in a solution within a container such that the article does not experience substantial or extended contact with the container interior. A predetermined flow of solution is passed into the container, thereby providing an upward force that, in conjunction with the buoyancy force, overcomes the downward gravitational force on the article when the article is more dense than the solution. Alternatively, if the article has a lower density than the treatment solution, the flow is generated at the top of the container to produce a substantially steady state effect.

U.S. Pat. No. 7,258,480, assigned to the assignee of the present application and incorporated herein by reference, discloses a mixing device for mixing solutions within a biochemical analyzer by moving a sampling probe needle in a two-dimensional, generally parabolic or generally “boomerang-shaped” mixing pattern of the probe needle.

Thus, there continues to be a need for an improved approach to the design of a simplified, space-efficient, liquid sample and or sample-reagent mixer. In particular, there is a continuing need for an improved sample-reagent solution mixer that provides high speed and mixing of solutions contained in tubes with a very high degree of uniformity in a desirably small amount of time.

### SUMMARY OF THE INVENTION

An object of the invention is to provide an improved mixing device for uniformly mixing solutions within a biochemical analyzer in reduced amounts of time without introducing unwanted bubbles, foam, or the like. The present invention comprises a magnetic mixer having a sampling probe needle attached to a moveable arm, the mixer reciprocating the moveable arm in first and second directions that are mutually perpendicular. In an exemplary embodiment, the moveable arm has a protruding foot supporting a vertical pin that contacts a roller bearing on a stationary block. The moveable arm is vibrated by an alternating electromagnet causing the pin to roll along the circumference of the roller bearing, whereby the arm is made to vibrate. Surprisingly, it has been discovered that the combination of restricting the magnitude of movement of the probe needle to a critical range, and also simultaneously vibrating the moveable arm in a narrow frequency range, produces a “lemniscate-shaped” mixing pattern of the probe needle. Such a lemniscate-shaped mixing pattern of the probe needle has been found to be extremely efficient in providing a high degree of mixing uniformity in a surprisingly short amount of time without inducing the formation of unwanted bubbles.

### BRIEF DESCRIPTION OF THE DRAWINGS

The invention will be more fully understood from the following detailed description thereof taken in connection with the accompanying drawings that form a part of this application and in which:

FIG. 1 is a schematic plan view of an automated analyzer adapted to perform the present invention;

FIG. 2 is an enlarged schematic plan view of a portion of the analyzer of FIG. 1;

FIG. 2A is perspective view of a reaction cuvette useful in operating the analyzer of FIG. 1;

FIG. 3 is perspective view of an aliquot vessel array useful in the analyzer of FIG. 1;

FIG. 4 is a perspective view of an aliquot vessel array storage and handling unit of the analyzer of FIG. 1;

FIG. 5 is perspective view of a reagent cartridge useful in operating the analyzer of FIG. 1;

FIG. 6 is a top plan view of a reagent cartridge management system useful in operating the analyzer of FIG. 1;

FIG. 7 is perspective view of a reagent cartridge useful in the reagent cartridge management system of FIG. 6;

FIG. 8 is a schematic representation of a liquid aspiration and dispensing system useful in the analyzer of FIG. 1;

FIG. 9 is a schematic representation of the liquid aspiration and dispensing system of FIG. 8 aspirating reagent from the reagent cartridge of FIG. 6;

FIG. 10 is a schematic representation of the liquid aspiration and dispensing system of FIG. 8 dispensing reagent into the reaction cuvette of FIG. 2A;

FIG. 11 is an enlarged diagram illustrating a prior art mixing pattern of motion;

FIG. 12 is a diagram illustrating a lemniscate-shaped mixing pattern of motion of the present invention;

FIG. 12A is a diagram illustrating the aspect ratio of the lemniscate-shaped mixing pattern of FIG. 12;

FIG. 13 is a side elevation view of the mixing assembly useful in performing the present invention;

FIG. 14 is a front view of the mixing assembly useful in performing the present invention;

FIG. 15 is a top view of the mixing assembly useful in performing the present invention;

FIG. 15A a schematic representation illustrating a liquid aspiration and dispensing system useful with the mixing assembly of the present invention;

FIG. 16 is a graph illustrating how the amplitude of motion of a moveable body portion and a probe needle tip portion of the mixing assembly of FIG. 13 vary with the frequency of operating said mixing assembly;

FIG. 17 is a graph illustrating how the mixing pattern of FIG. 12 varies with the frequency of the mixing assembly of FIG. 13;

FIG. 18 is a bottom view of the mixing assembly useful in performing the present invention illustrating a key feature for restricting the magnitude of movement of the moveable arm portion represented in FIG. 13; and

FIG. 19 is a graph illustrating how the range of amplitude of mixing motion varies as the magnitude of movement of the moveable arm portion seen in FIG. 13 is restricted.

### DETAILED DESCRIPTION OF THE INVENTION

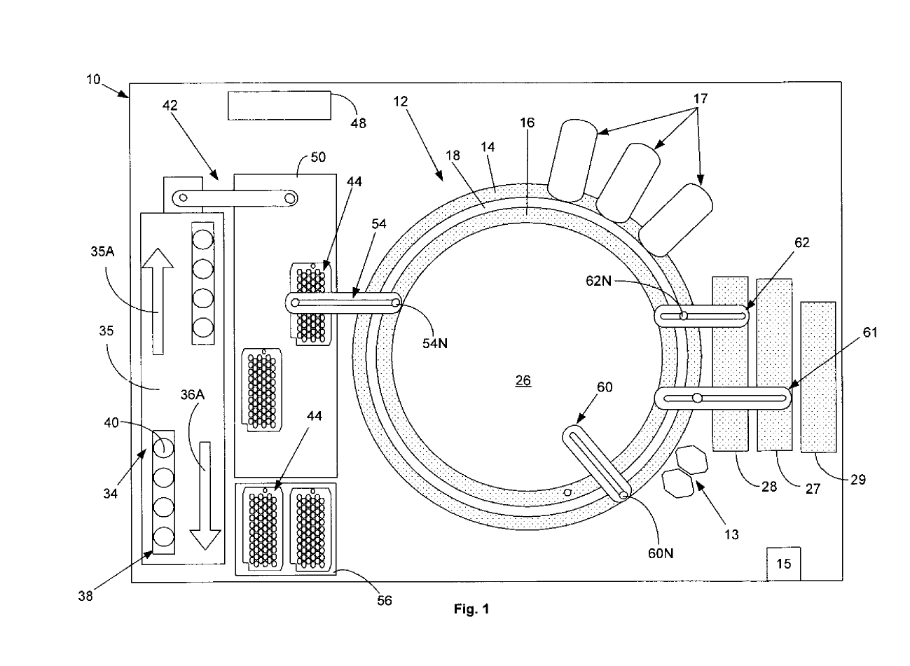

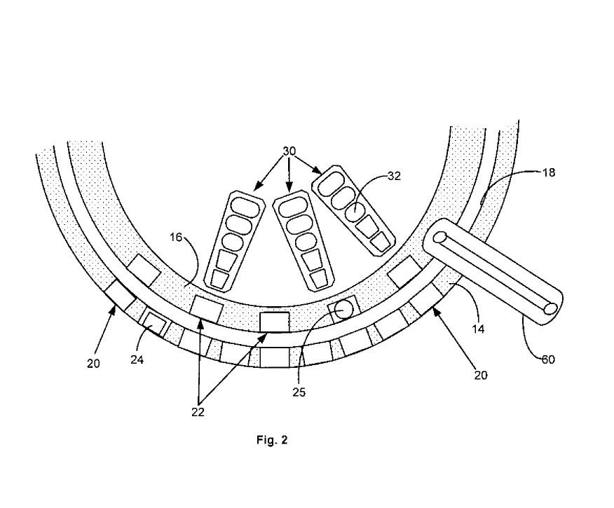

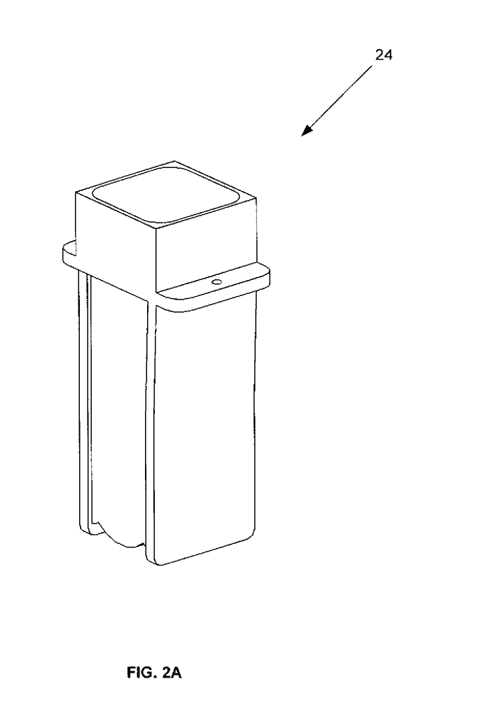

FIG. 1, taken with FIG. 2, shows schematically the elements of an automatic chemical analyzer 10 in which the present invention may be advantageously practiced, analyzer 10 comprising a reaction carousel 12 supporting an outer carousel 14 having cuvette ports 20 formed therein and an inner carousel 16 having vessel ports 22 formed therein, the outer carousel 14 and inner carousel 16 being separated by an open groove 18. Cuvette ports 20 are adapted to receive a plurality of reaction cuvettes 24, as seen in FIG. 2A, that contain various reagents and sample liquids for conventional clinical and immunoassay assays while vessel ports 22 are adapted to receive a plurality of reaction vessels 25 that contain specialized reagents for ultra-high sensitivity luminescent immunoassays. Reaction carousel 12 is rotatable using stepwise movements in a constant direction, the stepwise movements being separated by a constant dwell time during which reaction carousel 12 is maintained stationary and computer controlled assay operational devices 13, such as sensors, reagent add stations, mixing stations, and the like, operate as needed on an assay mixture contained within a cuvette 24.

Analyzer 10 is controlled by software executed by a computer 15 based on computer programs written in a machine language like that used on the Dimension® clinical chemistry analyzer sold by Siemens Healthcare Diagnostics Inc. of Deerfield, Ill., and widely used by those skilled in the art of computer-based electromechanical control programming. Computer 15 also executes application software programs for performing assays conducted by various analyzing means 17 within analyzer 10.

As seen in FIG. 1, a bi-directional incoming and outgoing sample fluid tube transport system 34 comprises a mechanism for transporting sample fluid tube racks 38 containing open or closed sample fluid containers such as sample fluid tubes 40 from a rack input load position at a first end of the input lane 35 to the second end of input lane 35 as indicated by open arrow 35A. Liquid specimens contained in sample tubes 40 are identified by reading bar coded indicia placed thereon using a conventional bar code reader to determine, among other items, a patient's identity, tests to be performed, if a sample aliquot is to be retained within analyzer 10, and, if so, for what period of time. It is also common practice to place bar coded indicia on sample tube racks 38 and employ a large number of bar code readers installed throughout analyzer 10 to ascertain, control, and track the location of sample tubes 40 and sample tube racks 38.

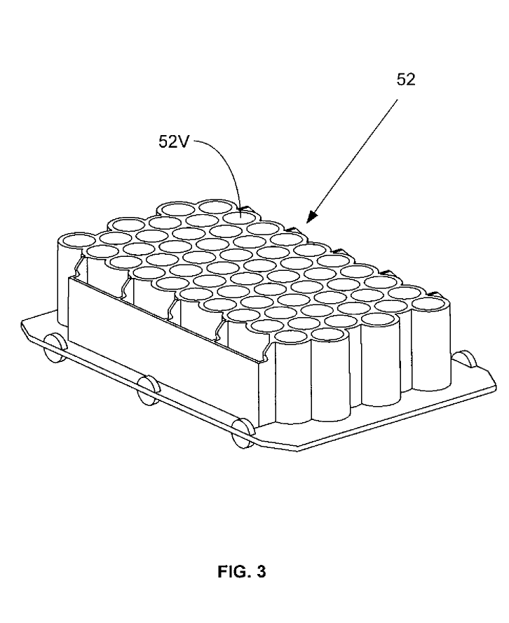

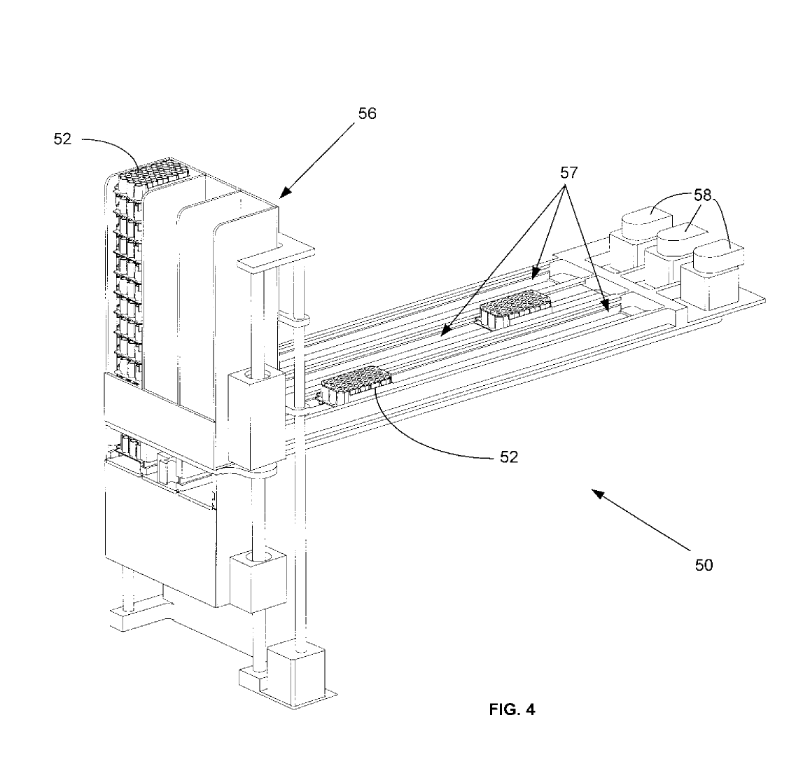

A conventional liquid sampling probe 42 is located proximate the second end of the input lane 35 and is operable to aspirate aliquot portions of sample fluid from sample fluid tubes 40 and to dispense an aliquot portion of the sample fluid into one or more of a plurality of vessels 52V in aliquot vessel array 44, seen in FIG. 3, depending on the quantity of sample fluid required to perform the requisite assays and to provide for a sample fluid aliquot to be retained by analyzer 10 within an environmental chamber 48. After sample fluid is aspirated from all sample fluid tubes 40 on a rack 38 and dispensed into aliquot vessels 52V and maintained in an aliquot vessel array storage and transport system 50 seen in FIG. 4, rack 38 may be moved, as indicated by open arrow 36A, to a front area of analyzer 10 accessible to an operator so that racks 38 may be unloaded from analyzer 10.

As shown in FIG. 4, aliquot vessel array transport system 50 comprises an aliquot vessel array storage and dispensing module 56 and a number of linear drive motors 58 adapted to bi-directionally translate aliquot vessel arrays 52 within a number of aliquot vessel array tracks 57 below a sample aspiration probe 54, described hereinafter and exemplary of the present invention, located proximate reaction carousel 12. Sample aspiration probe 54 is controlled by computer 15 and is adapted to aspirate a controlled amount of sample from individual vessels 52V positioned at a sampling location within a track 57 and is then shuttled to a dispensing location where an appropriate amount of aspirated sample is dispensed into one or more cuvettes 24 for testing by analyzer 10 for one or more analytes. After sample has been dispensed into reaction cuvettes 24, conventional transfer means move aliquot vessel arrays 52, as required, between aliquot vessel array transport system 50, environmental chamber 48, and a disposal area (not shown).

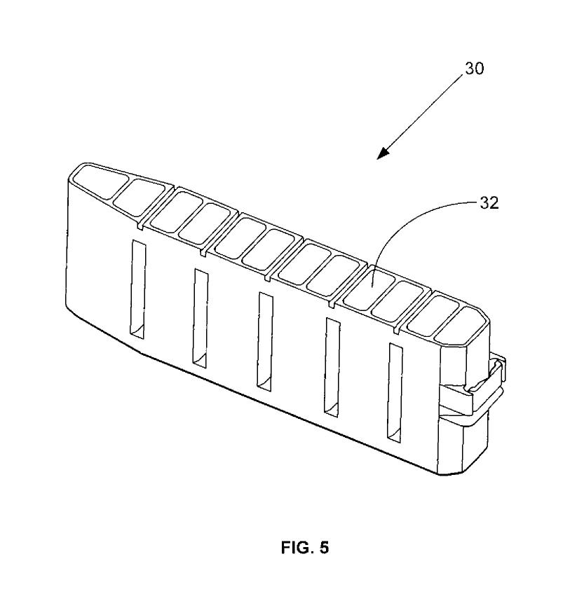

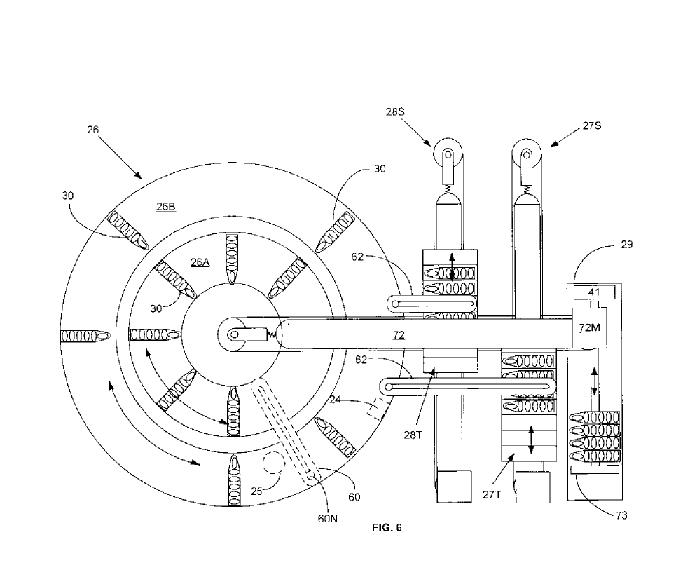

Temperature-controlled storage areas or servers 26, 27, and 28 contain an inventory of multi-compartment elongate reagent cartridges 30, like that illustrated in FIG. 5 and described in U.S. Pat. No. 6,943,030 assigned to the assignee of the present invention, containing reagents in wells 32, as necessary, to perform a number of different assays. As described later in conjunction with FIG. 6, server 26 comprises a first carousel 26A in which reagent cartridges 30 may be inventoried until translated to a second carousel 26B for access by a reagent aspiration probe 60 and lemniscate mixing assembly 55 exemplary of the present invention. FIG. 6 shows an advantageous embodiment in which carousel 26A and carousel 26B are circular and concentric, the first carousel 26A being inwards of the second carousel 26B. Reagent containers 30 may be loaded by placing such containers 30 into a loading tray 29 adapted to automatically translate containers 30 to a shuttling position described below.

Additional reagent aspiration probes 61 and 62 are independently mounted and translatable between servers 27 and 28, respectively and outer cuvette carousel 14. Probe 62 comprises conventional mechanisms for aspirating reagents required to conduct specified assays at a reagenting location from wells 32 in appropriate reagent cartridges 30, probe 62 subsequently being shuttled to a dispensing location where reagents are dispensed into cuvettes 24.

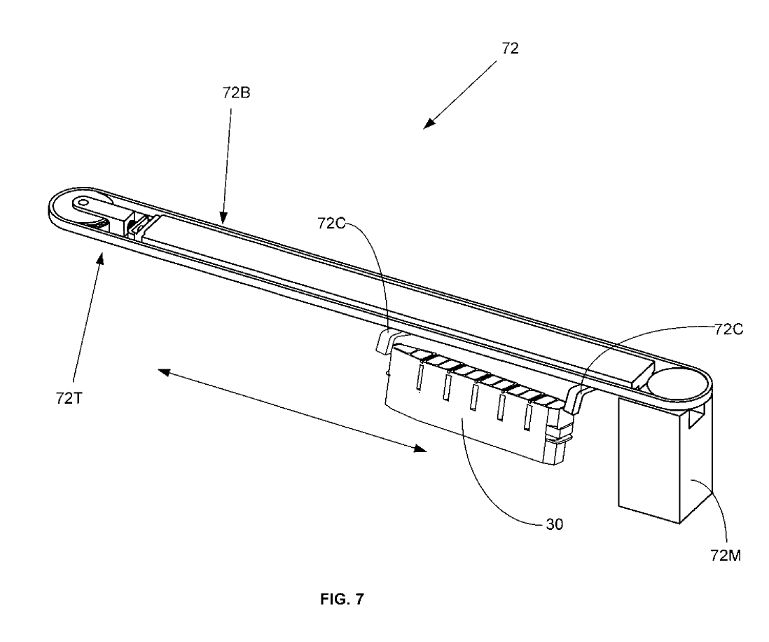

FIG. 6, taken with FIG. 7, illustrates a single, bi-directional carrier shuttle 72 adapted to remove reagent cartridges 30 from loading tray 29 having a motorized rake 73 that automatically locates reagent cartridges 30 at a shuttling position beneath shuttle 72. Cartridges 30 are identified by the type of reagent solution contained therein using conventional barcode-like indicia and a bar-code-reader 41 proximate loading tray 29. Computer 15 is programmed to track the location of each and every reagent cartridge 30 within analyzer 10. Shuttle 72 is further adapted to dispose a reagent container 30 into slots in at least one slotted reagent container tray 27T or 28T within at least one reagent storage area 27 or 28, respectively. In a similar fashion, shuttle 72 is further adapted to remove reagent containers 30 from reagent container trays 27T and 28T and to dispose such reagent containers 30 into either of two concentric reagent carousels 26A and 26B within reagent storage area 26. Shuttle 72 is also adapted to move reagent containers 30 between the two concentric reagent carousels 26A and 26B. As indicated by the double-headed arc-shaped arrows, reagent carousel 26A may be rotated in both directions so as to place any particular one of the reagent containers 30 disposed thereon beneath reagent aspiration probe 60. Any one of the reagent containers 30 disposed in reagent container trays 27T and 28T may be located at a loading position beneath reagent container shuttle 72 or at a reagent aspiration location beneath aspiration and dispensing probe 62, respectively, by reagent container shuttles 27S and 28S within reagent storage areas 27 and 28, respectively. Reagent container shuttles 27S and 28S are similar in design to reagent container shuttle 72 seen in FIG. 7. Reaction cuvettes 24 supported in outer carousel 14 and reaction vessels 25 supported in inner carousel 16 are shown in dashed lines to indicate that they are positioned below the surface of carousel 26.

Carrier shuttle 72 seen in FIG. 7 is adapted to automatically compensate for unknown changes in length of a belt 72B driven by motor 72M by an automated tensioner 72T like described in U.S. Pat. No. 7,207,913 and assigned to the assignee of the present invention, and adapted to maintain a constant tension on the belt 72B regardless of rapid changes in its driving direction so that reagent containers 30 attached thereto by clamps 72C may be accurately positioned along the direction of belt 72B, as indicated by the double-ended arrow, and disposed at their shuttling location beneath reagent container shuttle 72 or within storage areas 26, 27, or 28 as belt 72B wears. Reagent container shuttles 27S and 28S are similar in design to one another and include a reagent container tray 28T secured to one leg of a belt so that tray 28T is free to be driven to and from along the direction of by the double-ended arrow. Consequently, reagent containers 30 within slots in tray 28T may be automatically positioned at a shuttling location beneath container shuttle 72.

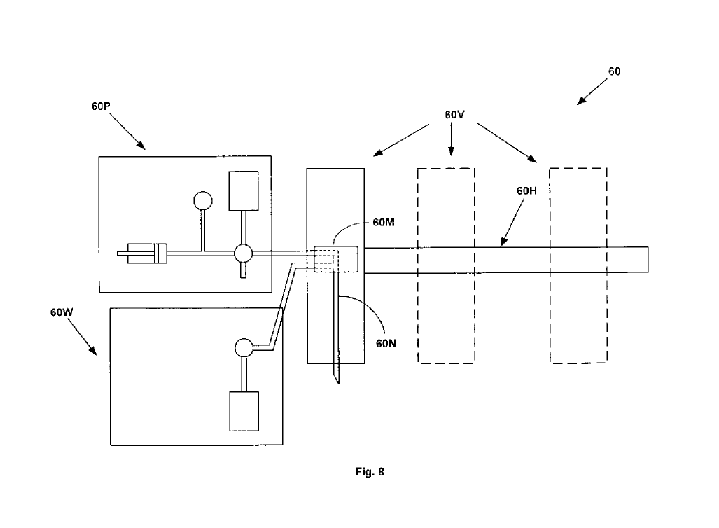

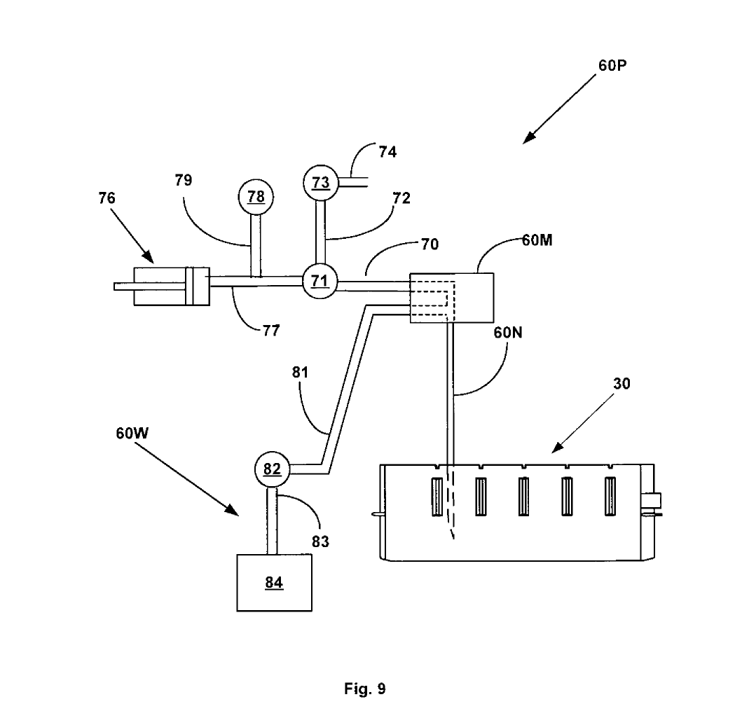

Aspiration probe 60, which is useful in performing the present invention, may be seen in FIG. 8 as comprising a horizontal drive component 60H, a vertical drive component 60V, a wash module component 60W, a pump module component 60P, an aspiration and dispensing probe needle 60N with a tapered needle tip 60T designed to reduce the orifice size and enhance aspiration volumes when inserted through the covering of reagent cartridge 30, and a wash manifold component 60M having the primary functions described in Table 1 below. Components of the wash module component 60W and pump module component 60P identified in FIG. 9 will be described below. Horizontal drive component 60H and vertical drive component 60V are typically computer controlled stepper motors or linear actuators and are controlled by computer 15 for providing precisely controlled movements of the horizontal drive component 60H and vertical drive component 60V.

TABLE 1

| Module | Primary Functions |
|---|---|
| Horizontal | Position the vertical drive 60V over reagent cartridges 30 |
| Drive 60H | containing reagent liquids and carried in a vial rack 30A |
| | and over cuvettes 24 carried in ports 20. |
| Vertical | Drive probe 60N through the covering of a reagent |
| Drive 60V | cartridge 30. |
| Wash | Remove contamination from probe tip 60T with liquid |
| Module 60W | cleansing solutions. |
| Wash | Connect probe tip 60T to pump module 60P |
| Manifold 60M | |
| Pump | Pump reagent liquids and sample fluids. |
| Module 60P | |
| Probe | Aspirate and dispense reagent liquids and sample fluids. |
| Needle 60N | |

FIG. 9 shows pump module 60P connected to conventional hollow, liquid-carrying probe tip 60T having conventionally defined interior and exterior surfaces and supported by wash manifold 60M, the wash manifold 60M being connected by a hollow air tube 70 to a three-way valve 71. Probe needle 60N may be connected to wash manifold 60M using any of several screw-like connectors (not shown) or, alternately, permanently welded thereto. Valve 71 is operable to optionally connect air tube 70 to (1) a vent valve 73 connected to an atmospheric vent tube 74, or (2) a piston-type syringe pump 76 by a hollow air tube 77. A conventional air pressure measuring transducer 78 is connected to air tube 77 between pump 76 and valve 71 by a hollow air tube 79.

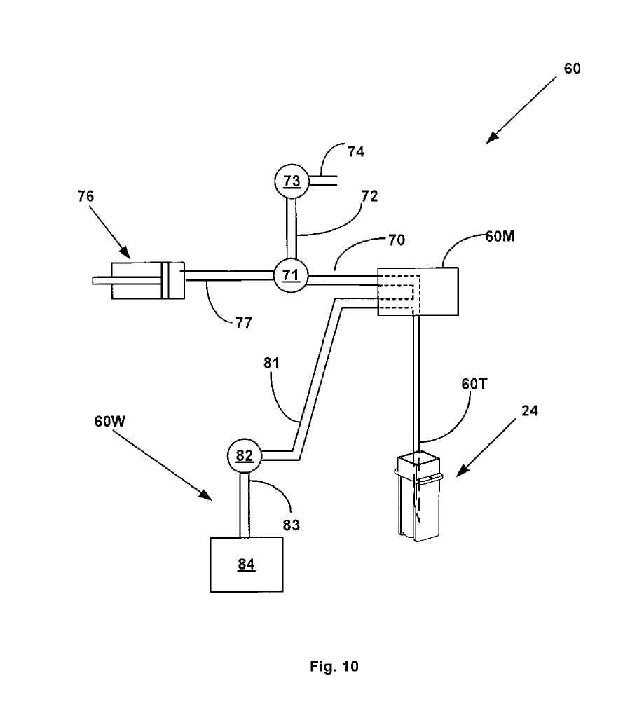

FIG. 9 also illustrates probe needle 60N having punctured the covering of a reagent carrier 30 and positioned within a reagent liquid contained therein. Level sensing means (for example, using well known capacitive signals) may be advantageously employed in order to ensure that probe needle 60N is in fluid communication with the liquid. Piston 76 is activated and the distance it is moved is controlled by computer 15 so that a controlled volume of reagent liquid is withdrawn or aspirated into probe needle 60N. During this process, valve 71 is closed to vent tube 72, but is open to air tube 77 and air tube 70. Valve 71 is operable to optionally connect air tube 70 to an optional vent valve 73 connected to an atmospheric vent tube 74. FIG. 9 also shows an optional wash manifold 60W as comprising a flush valve 82 connected to wash manifold 60W by a hollow liquid carrying tube 81. Flush valve 82 is operable to connect liquid carrying tube 81 to a pressurized rinse water source 84 by a hollow liquid tube 83. After aspiration of calibration or quality control liquid from reagent carrier 30 is completed, wash manifold 60M is raised by vertical drive 60V and positioned by horizontal drive 60H so that probe 60 may dispense calibration or quality control liquid into a cuvette 24 carried in port 20 in carousel 14 as illustrated in FIG. 10.

During operation of analyzer 10 using the devices illustrated in FIGS. 2-9, there are several instances when it is critical that liquids or solutions of one or more liquids be quickly and uniformly mixed, producing a demand for a mixing device that mixes a liquid or liquid solution to a high degree of uniformity at very high speed, without unduly increasing analyzer cost or requiring a disproportional amount of space or a specialized mixing-only device. High speed mixing to obtain a uniformly dispersed solution might be required, for example:
1. After sample aspiration probe 60 extracts a first reagent from a first reagent cartridge 30 and dispenses reagent into a reaction cuvette 24;
2. Before sample aspiration probe 54 extracts sample from a vessel 52V in aliquot vessel array 52 and dispenses sample into a reaction cuvette 24; or
3. After sample aspiration probe 54 extracts a second reagent from a second reagent cartridge 30 and dispenses reagent into reaction cuvette 24.

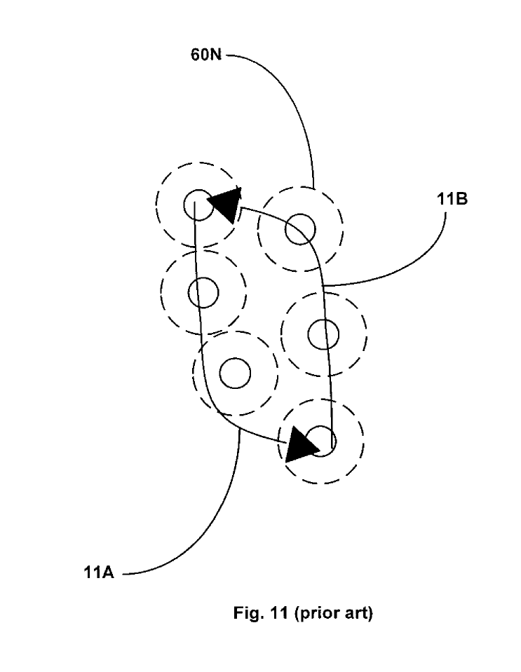

Prior art mixing methods typically move a sampling probe needle in either a linear mixing pattern or circular or elliptical mixing pattern. Linear mixing patterns are inefficient in terms of requisite duration. And, although circular or elliptical patterns produce efficient mixing, an undesirable side-effect is the formation of air bubbles at the lower tip of the vortex generated by the circular mixing pattern. The bubbles are then suspended within the solution for some period of time before rising to the surface. Another prior art mixing pattern moves the sampling probe in a two-dimensional, generally parabolic or generally “boomerang-shaped” mixing pattern like seen in FIG. 11. This approach, however, requires an undesirable long amount of time to produce a mixed solution that is acceptably uniform for so-called “mix sensitive” immunoassays.

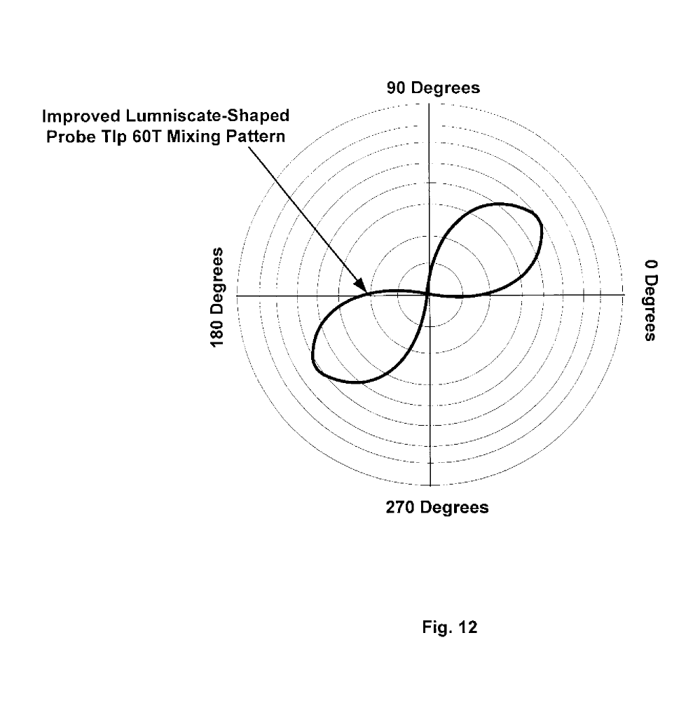

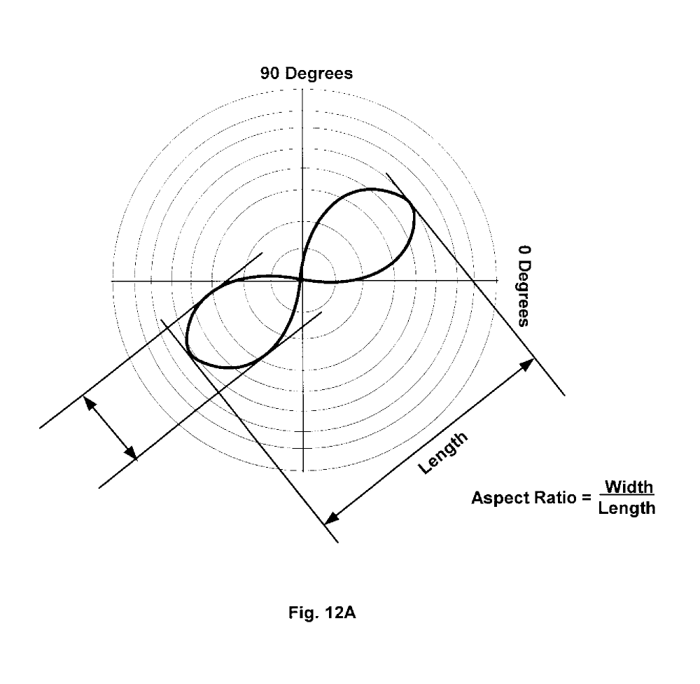

A key feature of the present invention is the discovery that an unexpectedly high degree of mixing uniformity in an short amount of time may be achieved without the generation of undesirable bubbles by rapidly moving probe tips 54T, 60T, or 62T in a “figure-8” or “lemniscate-shaped” mixing pattern, like illustrated in FIG. 12, within sample retained in vessels 52V in aliquot vessel array 44, or within sample-reagent mixture in cuvette 24 after the dispensing process illustrated in FIG. 10.

The mixing action provided by the present invention cycles probe tip 60T in a generally lemniscate-shaped mixing pattern like seen in FIG. 12. It has been discovered that in maintaining the aspect ratio as illustrated and defined in FIG. 12A, such a lemniscate-shaped mixing pattern produces a very efficient mix in terms of length of mixing time, uniformity of mix (as measured by under-mix sensitive clinical assay methods), and the minimization of bubble formation (as measured by the size of the transient response following the mix of over-mix sensitive clinical chemistry methods, typically plasma-protein type methods). Thus, the lemniscate-shaped mixing pattern is advantageous for use in clinical analyzers as it permits the widest possible operating range over a wide range of clinical chemistry detection methods. Surprisingly, the lemniscate pattern is an improvement over the circular or elliptical patterns due to meeting multiple requirements of homogenized mix results, minimized bubble formation, and 500 milliseconds (ms) mix time for fluid volumes ranging from 40-250 micro-liters (uL). In particular, it has been discovered that for liquid solutions having viscosities like those found in conventional clinical chemistry reagent-patient sample solutions, the amplitude of motion of probe tips 54T, 60T, and 62T of probe needles 54N, 60N, and 62N must remain within a desired range of about 1.7 to 2.6 mm, and at the same time, the frequency at which moveable arm 85 (from which probe tips 54T, 60T, and 62T depend) is vibrated must also remain within a certain frequency range in order to produce a successful lemniscate-shaped mixing pattern. In such cases, the term “successful” mixing processes is intended to identify mixing processes that produce at least a 97% degree of solution uniformity, that are completed in an amount of time less than about 500 milliseconds, and that do not generate non-uniformities like bubbles or foam within the solution.

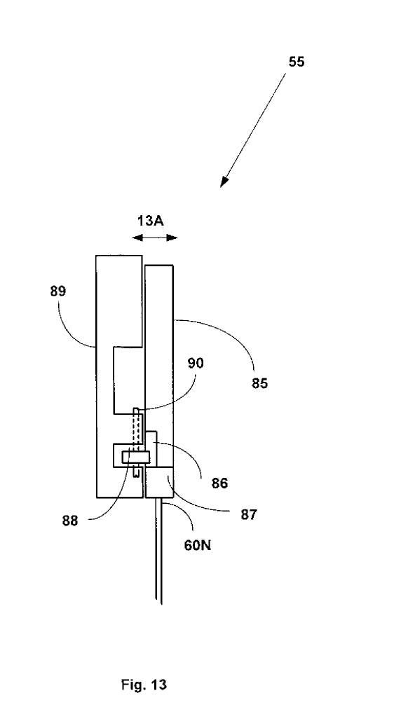

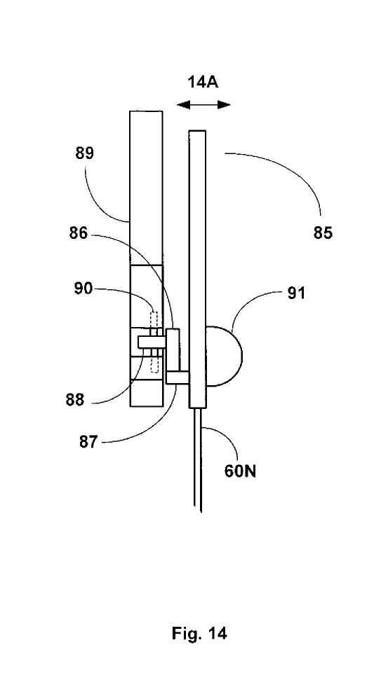

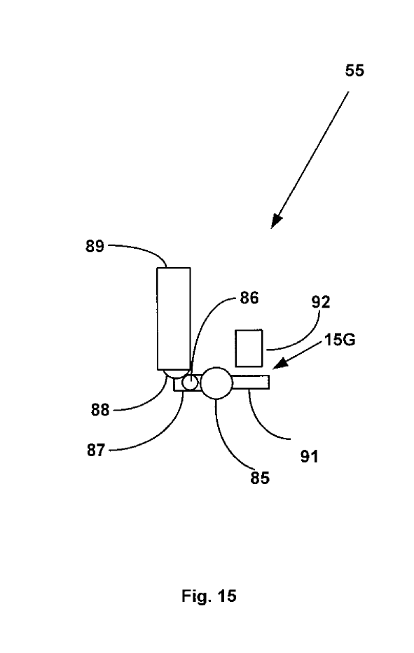

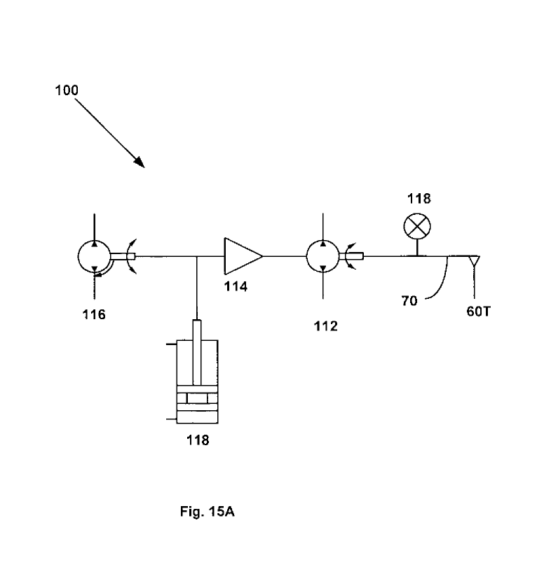

Such a lemniscate-shaped mixing pattern can be achieved using a mixing assembly having probe needle tip 60T depending from a moveable arm attached to a magnetic plate with reciprocating means adapted to reciprocate the moveable arm in a lemniscate-shaped mixing pattern. Typically, the moveable arm comprises a bias mechanism and a stationary curved surface in contact therewith. For example, the lemniscate-shaped mixing pattern can be produced using the mixing assembly seen in FIG. 13, a side view of needle probe 60N depending from moveable body 85, body 85 having a protruding foot 87 supporting a first pin 86 extending vertically upwards and in contact with a curved surface provided by a roller bearing 88 mounted to a stationary block 89 using a second pin 90. As seen in FIG. 14 (a front view of magnetic mixing assembly 55) and FIG. 15 (a top view of magnetic mixing assembly 55), probe body 85 may be vibrated using a conventional alternating electromagnet 92 positioned proximate a ferromagnetic plate 91. Such vibration of the moveable body 85 causes roller pin 86 to roll back and forth along the circumference of roller bearing 88 so that arm 85 reciprocates in first and second directions that are mutually perpendicular. FIG. 15A shows an alternate pump module 100 comprising liquid-carrying probe tip 60T connected by hollow air tube 70 to metering pump 112 connected to a conventional flush valve 114. Valve 114 is operable to connect air tube 70 to a flush pump 116 or to a piston-type water supply 118. A conventional air pressure measuring transducer 120 is connected between probe tip 60T and metering pump 112.

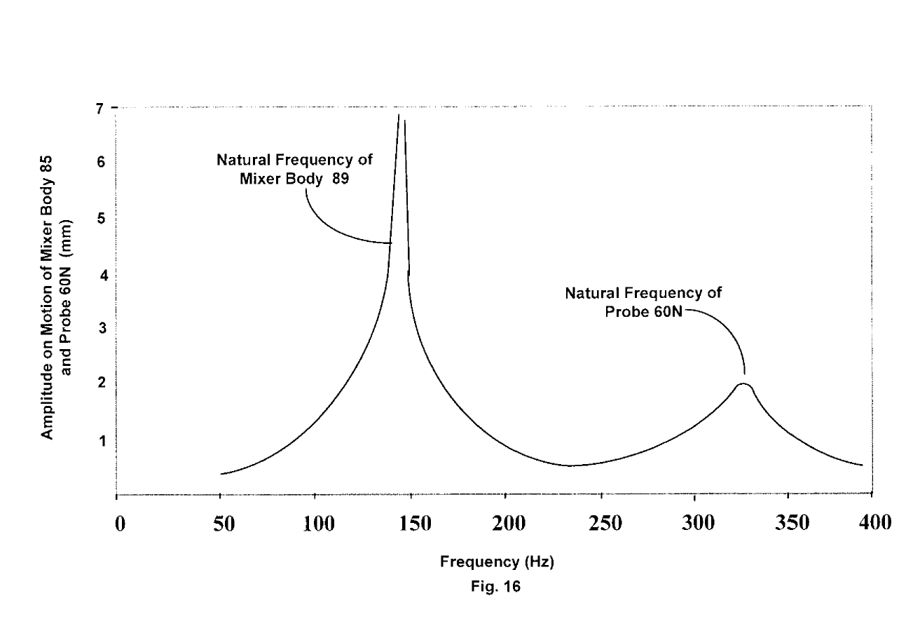

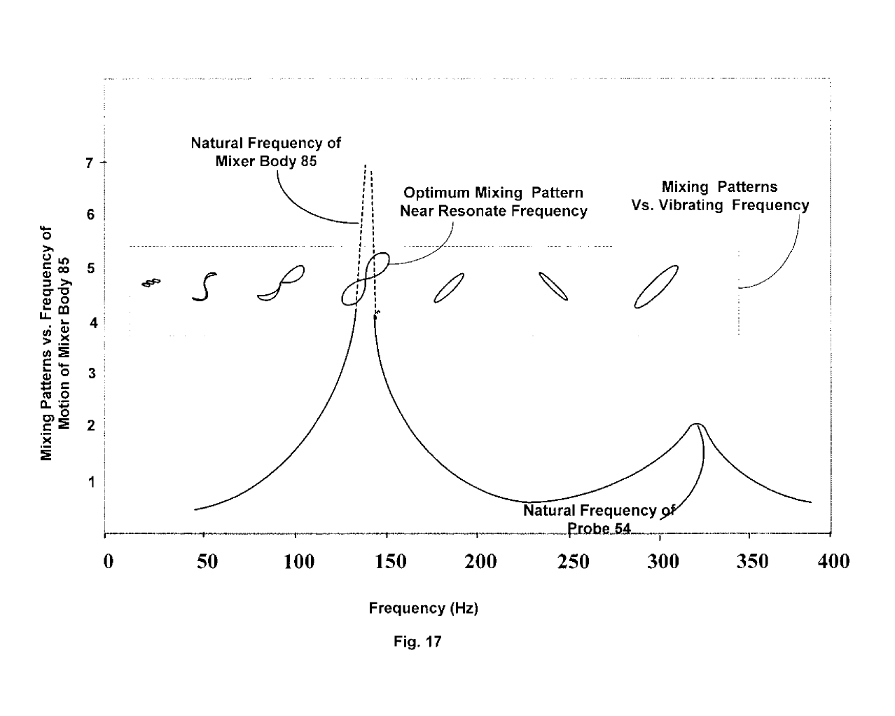

FIG. 16 illustrates how the amplitude of motion of moveable body 85 and the probe needle tip 60T vary as the frequency at which electromagnet 92 vibrates moveable body 85. The moveable body 85 is seen to have a natural or resonate frequency centered in the general range of about 125-150 Hz, which results in a maximum amplitude of vibration in this same general range. Because the probe needle 60N is smaller and has less mass, the needle tip 60T is seen to have a natural or resonate frequency centered in a higher frequency range of about 310-340 Hz, producing a maximum amplitude of vibration in this same general range. It has been discovered that the pattern of movement that is produced in probe needle 60N progresses from a series of several “connected small ovals” to a lemniscate-shaped mixing pattern as the vibrating frequency is increased towards the natural frequency of moveable body 85. This is illustrated in FIG. 17, where it also has been discovered that when the vibration frequency is increased above the resonate frequency of mixer body 85, the mixing pattern of probe 60T tends to be oval-shaped. Further, when the vibration frequency is decreased below the resonate frequency of mixer body 85, the mixing pattern of probe 60T loses identity. Basically, varying the frequency of vibration of the probe body 85 produces a variety of “lemniscate-shaped” mixing patterns of probe 60T like those seen in FIG. 17, where an optimum lemniscate-shape movement of probe tip 60T has been found to occur in a band of frequencies centered at the natural or resonate frequency of mixer body 85.

Because both the lowermost portion of probe needle 60N and probe tip 60T provide the mixing action of solutions within a reagent cartridge 30, reaction cuvette 24, or vessel 52V in aliquot vessel array 52, prior art experiences would seemingly point to the desirability of having a maximum amplitude of mixing motion of needle tip 60T. However, too great an amplitude of mixing motion of needle tip 60T may cause a condition known as “over-mix,” in particular for plasma protein assays wherein nephelometric measuring techniques are employed. It therefore becomes desirable to carefully control the range of amplitude of mixing motion of needle tip 60T.

Table 2 below summarizes the effect on assay results for a range of amplitudes of motion for the needle tip 60T with consequence impact on the aspect ratio of the lemniscate-shaped mixing pattern seen in FIG. 12. It can be seen that a desirable range of amplitudes of motion for the probe tip 60T is in the range of about 1.7 to 2.6 mm (within the bold box lines), which produces a lemniscate-shaped mixing pattern with an aspect ratio between 0.4 and 0.6, In addition, maintaining the amplitude of motion for the probe tip 60T in the range of about 1.7 to 2.6 mm is not detrimental on the results of a number of assays known to be over-mix sensitive.

TABLE 2

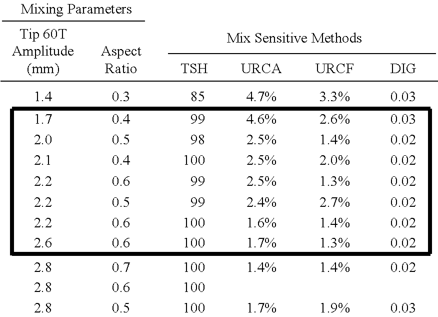

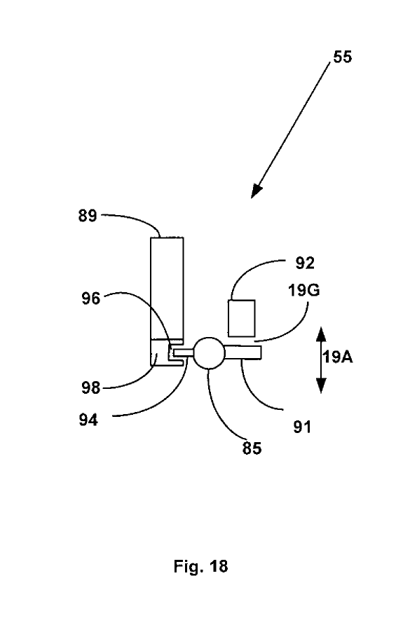

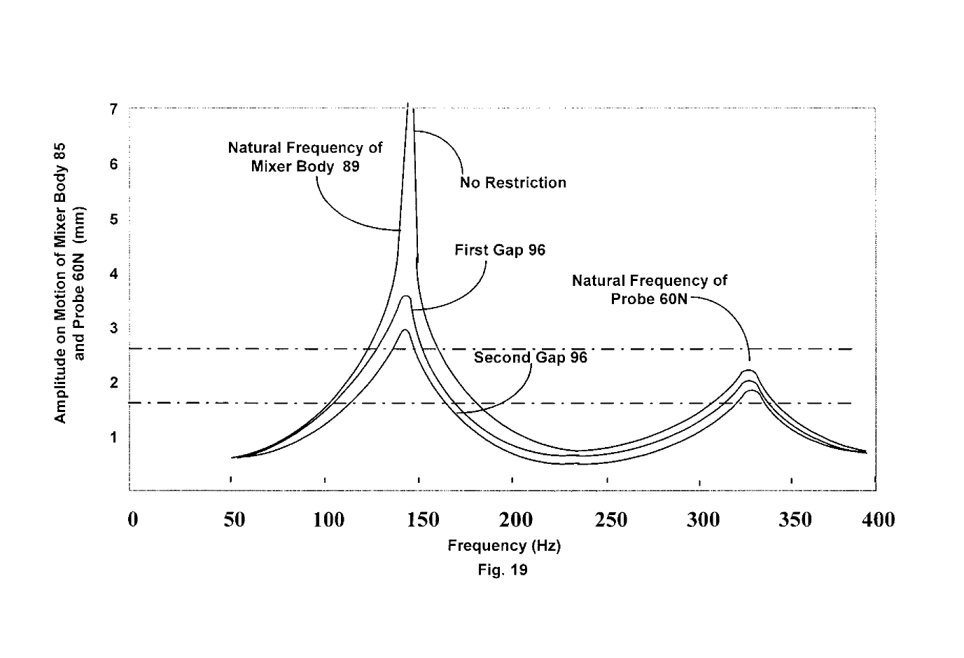

A small tab 94 at the bottom of moveable body 85 is positioned within a gap 96 designed into a lowermost portion 98 of stationary block 89 as seen in FIG. 18 (a bottom view of mixing assembly 55). Tab 94 is a factor in controlling the range of amplitude of mixing motion of needle tip 60T. The dimensions of tab 94 and gap 96 may be changed to reduce the amplitude of motion of moveable body 85 in the direction indicated by arrow 19A, therefore reducing the corresponding amplitudes of motion of probe needle 60N and needle tip 60T. This effect is illustrated in FIG. 19, where it has remarkably been found that the amplitude of motion of needle tip 60T remains within a reasonably small range even though dramatic reductions are made in the amplitude of motion of moveable body 85.

FIG. 19 illustrates how the range of amplitude of motion for the probe tip 60T may be maintained in the range of about 1.7 to 2.6 mm by varying the magnitude of gap 96 within a range between a first and second empirically determined values. Optimally, the design parameters of magnetic mixing assembly 55 are selected so that a “good” mix is achieved in 0.5 seconds or less, and foam is not generated. A “good” mix is defined as having signal variation less than 2% deviation from a zero baseline. What has been discovered is that, depending upon the stiffness of the probe needle 60N used, an air gap 14G distance between electromagnet 92 and plate 91, the magnitude of gap 96, and the frequency of vibration of moveable body 85 must be adjusted to fall within ranges that produce a lemniscate-shaped mixing pattern displacement of the tip of probe needles 54N, 60N, and 62N in a range from about 1.7 to about 2.6 mm with an aspect ratio of about 0.5.

It should be readily appreciated by those persons skilled in the art that the present invention is susceptible of a broad utility and application. Many embodiments and adaptations of the present invention other than those herein described, as well as many variations, modifications, and equivalent arrangements will be apparent from, or reasonably suggested by, the present invention and the foregoing description thereof, without departing from the substance or scope of the present invention. For example, a vibratory motor could be used instead of an electromagnet and a magnetic plate to cause vibrating motion. Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention, or otherwise to exclude any such other embodiments, adaptations, variations, modifications, and equivalent arrangements, the present invention being limited only by the claims appended hereto and the equivalents thereof.

What is claimed:

1. An improved method for mixing a solution within a clinical analyzer, the method comprising:
a) providing a mixing assembly comprising:
a probe needle depending from a moveable arm and in contact with the solution, the moveable arm having a magnetic plate attached thereto,
reciprocating means adapted to reciprocate the moveable arm,
the moveable arm comprising a bias mechanism, and
a stationary curved surface in contact with said bias mechanism;
b) wherein the improvement comprises reciprocating the moveable arm so as to cause the bias mechanism to roll along the curved surface, whereby the probe needle is reciprocated in a generally lemniscate shaped pattern.

2. The improved method of claim 1, wherein the reciprocating means comprises an electromagnet proximate the magnetic plate.

3. The improved method of claim 1, wherein the bias mechanism comprises a foot protruding from the moveable arm, the foot comprising a pin extending vertically upwards.

4. The improved method of claim 1, wherein the generally lemniscate shaped pattern has an aspect ration of about 0.5.

5. The improved method of claim 1, wherein
reciprocating takes place over a time interval of about between 200 and 750 milliseconds,
the solution comprises a volume in the range of about 25 to 250 uL, and
greater than a 97% degree of uniform mixing is achieved.

6. The improved method of claim 1, wherein the frequency of reciprocating the moveable arm is within a 50 Hz range of frequencies centered about the natural frequency of the moveable arm.

7. The improved method of claim 1, wherein the stationary block has a gap formed therein and the moveable arm has an extending tab positioned within the gap such that the amplitude of mixing motion of the tip of the probe is in the range of about 1.7 to 2.5 mm.
